(19) United States
(12) Patent Application Publication
(10) Pub. No.: US 2013/0339187 A1
(43) Pub. Date: Dec. 19, 2013

(54) System for Delivering Invoices Over a Secure Messaging Network

(71) Applicant: Stephen Michael Carter, Camberley (GB)

(72) Inventor: Stephen Michael Carter, Camberley (GB)

(73) Assignee: Bottomline Technologies (DE) Inc., Portsmouth, NH (US)

(21) Appl. No.: 13/523,448

(22) Filed: Jun. 14, 2012

(51) Int. Cl. G06Q 30/06

(52) U.S. Cl. 705/26.41

(57) ABSTRACT

A system for delivering invoices over the SWIFT Network to a community of buyers comprises an invoice viewer at each buyer's location, each connected to a shared data center over the Internet. The shared data center comprises a SWIFT interface and BIC for receiving, and a database for storing, invoice objects for each buyer. At a first invoice object includes identification of a first buyer and at least a second invoice object includes identification of a second buyer. A group of buyer records associated each unique buyer with unique access credentials. A delivery application provides a connecting buyer's invoice objects in response to a web services call from the connecting buyer. An invoice viewer generates the web services call, receives the response, and renders a user interface displaying information from each interface object.

### TECHNICAL FIELD

The present invention relates to electronic delivery of invoices and more particularly, to a system for delivering invoices over a secure messaging network to each buyer of a community of buyers, independent of whether each buyer is connected to the secure messaging network.

### BACKGROUND OF THE INVENTION

In 1977 the Society for Worldwide Interbank Financial Telecommunication (SWIFT) began operations of what is known as the SWIFT Network. The SWIFT Network is a secure network used by member banks for routing properly formatted messages to other member banks. Each bank is identified by a Bank Identifier Code (BIC). When a message is transmitted, the destination bank is identified by its BIC.

By 1987 SWIFT expanded the user base beyond member banks by permitting other financial companies such as broker dealers, exchanges, central depositors and clearing institutions to obtain BICs and route messages over the SWIFT network.

Over the following years SWIFT's user base continued to expand to more diverse corporate customers. Additionally, the diversity of standardized types of SWIFT messages has continued to expand. For example, non-bank commercial users can send an invoice, in a standard SWIFT format, to another non-bank commercial user, using messaging or bulk file transfer and addressing the invoice to the destination user's BIC.

One challenge with use of the SWIFT network for delivery of invoices to a corporate's customers (i.e. buyer's of the customer's products or services) is that not all buyer's are part of SWIFT's user base. The corporate cannot deliver an invoice over the SWIFT network to a buyer that does not have a BIC to which invoice can be routed.

In view of the foregoing, what is needed is a system which interfaces with a secure messaging network, such as the SWIFT network, in a manner which provides for electronic delivery of invoices over the secure messaging network to each buyer of a community of buyers, independent of whether each buyer is part of the user base of the secure network or otherwise connected to the secure messaging network for receipt of messages.

### SUMMARY OF THE INVENTION

A first aspect of the present invention comprises a system for interfacing with the Society for Worldwide Interbank Financial Telecommunication (SWIFT) Network for delivery invoices to each buyer of a community of buyers.

The system includes a shared data center. The shared data center comprises a bank identification code (BIC) identifying the shared data center as an addressable endpoint on the SWIFT Network and a SWIFT Network Interface connecting the shared data center with the SWIFT Network and receiving SWIFT invoice formatted messages addressed to the BIC.

The shared data center also includes a database encoded to computer readable medium. The database comprises a group of invoice objects. Each invoice object comprises at least: i) a header comprising the BIC of the shared data center and identification of destination buyer and ii) invoice data. The destination buyer may be one of the buyers of the group of buyers.

The invoice objects included in the database comprises: i) at least a first invoice object including identification of a first destination buyer; and ii) at least a second invoice object including identification of a second destination buyer unique from the first destination buyer.

The database further includes a group of buyer records. Each buyer record may be associated with, and identify a unique buyer of the group of buyers. The buyer record may also include access credentials unique to the unique buyer.

The access credentials may include identification of a digital certificate for each individual (the subject certificate holder) that has permission to access the shared data center on the buyer's behalf.

The shared data center may further include a delivery application comprising instructions stored in a computer readable memory and executed by a processor. The instructions of the delivery application provide for receiving web services calls from a connecting buyer. The connecting buyer is one of the buyers of the group of buyers.

In response to an obtain invoice web services call which includes access credentials of a subject authorized to connect to the shared data center on behalf of the connecting buyer, the instructions provide for: i) validating that the access credentials within the web services call match access credentials for an authorized subject within a buyer record of one of the unique buyers; ii) retrieving from the database those invoice objects which include identification of a destination buyer in the header which matches identification of the connecting buyer; and iii) providing those retrieved invoice objects to the connecting buyer in response to the web services call.

The system further includes an invoice viewer comprising instructions coded to a computer readable memory and executed by a processor. At lease one invoice viewer is present at each connecting buyer's location—which is remote from the shared data center.

The instructions of the invoice viewer comprise at least invoice retrieval instructions and user interface instructions. The invoice retrieval instructions comprise at least: i) generating a web services call to the delivery application, the web services call comprising the connecting buyer's access credentials; ii) receiving, in response to the web services call, a group of invoice objects which include identification of the connecting buyer within the header of the invoice object; and iii) storing the invoice objects in a local database.

The user interface instructions comprise at least: i) rendering, within a first frame of a user interface display, summary information for each invoice received in response to the web services call; and iii) rendering, within a second frame of the user interface display, detailed information of a selected invoice object, the selected invoice object being a one of the invoices received in response to the web services call.

In one sub aspect, the shared data center may further comprise a group of invoice rendering templates. Each invoice rendering template may include static invoice content in one language of a group of distinct languages.

In this sub aspect, the instructions of the delivery application may include a web service which provides an invoice, rendered with the template with static content in a specific language, and in a specified format, in response to a download invoice web services call.

The instructions of such web service may, in response to receipt of a download invoice web services call that includes access credentials of the connecting buyer and identification of an invoice object provide for at least: i) validating that the access credentials within the web services call match access credentials within a buyer record of one of the unique buyers; ii) retrieving from the database the identified invoice object; iii) looking up a rendering language, the rendering language being a language selected by the user (the subject to which the digital certificate is assigned) for rendering of invoices; and iv) populating the invoice data of the identified invoice object to the invoice rendering template with static content in the rendering language to generate a language specific formatted document file; and v) providing the formatted document file to the connecting buyer.

In this sub aspect, each buyer record in the database of the shared data center may include identification of the rendering language selected by each user (i.e. the subject to which the digital certificate is assigned and who is authorized to connect on behalf the buyer) for rendering invoices. As such, looking up the rendering language comprises looking up the rendering language in the buyer record associated with the subject establishing the connection on behalf of the connecting buyer.

Alternatively, the download invoice web services call may include identification of the rendering language and, in which case, the shared data center, when looking up the rendering language, comprises looking up the rendering language in the web services call received from the connecting buyer.

In another aspect, the invoice viewer further includes a group of user interface rendering templates. Each user interface rendering template may comprise static content of the user interface display in one language of a group of distinct languages. In this aspect the computer readable media at the connecting buyer's location comprises identification of a selected language, the selected language being a language selected, from a group of unique languages, by the user for the user interface.

In this aspect the user interface instructions of the local viewer application further comprise: i) looking up a selected language from the computer readable media; and ii) rendering, by use of the user interface rendering template with static content in the selected language, each frame of the user interface which, as discussed, includes at least the summary information for each invoice received in response to the web services call within the first frame of the user interface display and the detailed information of the selected invoice object within the second frame of the user interface display.

In another aspect wherein the invoice viewer includes a group of user interface rendering templates with static content in each of multiple distinct languages, the response to the web services call may further comprises identification of the selected language. The instructions of the delivery application may look up the language associated with the connecting user and populate that language as the selected language in the response to the web services call.

As such, the user interface instructions of the local viewer application further comprise: i) looking up a selected language from the response to the web services call; and ii) rendering, by use of the user interface rendering template with static content in the selected language, each frame of the user interface which, as discussed, includes at least the summary information for each invoice received in response to the web services call within the first frame of the user interface display and the detailed information of the selected invoice object within the second frame of the user interface display.

For a better understanding of the present invention, together with other and further aspects thereof, reference is made to the following description, taken in conjunction with the accompanying drawings. The scope of the invention is set forth in the appended claims.

### BRIEF DESCRIPTION OF THE DRAWINGS

FIG. 1 is a block diagram representing architecture of a system for delivering invoices over the SWIFT Network to a community of buyers in accordance with an exemplary embodiment of the present invention;

FIG. 2 is a diagram representing an invoice database in accordance with an exemplary embodiment of the present invention;

FIG. 3 is a diagram representing an invoice object in accordance with an exemplary embodiment of the present invention;

FIG. 4 is a diagram representing a buyer registry in accordance with an exemplary embodiment of the present invention;

FIG. 5a is a diagram representing an invoice rendering template, in a first language, in accordance with an exemplary embodiment of the present invention;

FIG. 5b is a diagram representing an invoice rendering template, in a second language, in accordance with an exemplary embodiment of the present invention;

FIG. 6a is a diagram representing user interface rendering template, in a first language, in accordance with an exemplary embodiment of the present invention;

FIG. 6b is a diagram representing user interface rendering template, in a second language, in accordance with an exemplary embodiment of the present invention;

FIG. 7 is a diagram representing exemplary rendering of a user interface on a display screen in accordance with an exemplary embodiment of the present invention;

FIG. 8 is a diagram representing a local database in accordance with an exemplary embodiment of the present invention;

FIG. 9a is a diagram representing exemplary general operation of a local viewer application in accordance with an exemplary embodiment of the present invention;

FIG. 9b is a diagram representing exemplary operation of a local viewer application with respect to obtaining invoice objects from the shared data center in accordance with an exemplary embodiment of the present invention;

FIG. 9c is a diagram representing exemplary operation of a local viewer application with respect to downloading a formatted invoice from the shared data center in accordance with an exemplary embodiment of the present invention;

FIG. 10a is a diagram representing a get invoices web services call in accordance with an exemplary embodiment of the present invention;

FIG. 10b is a diagram representing a download formatted invoice (PDF) in accordance with an exemplary embodiment of the present invention;

FIG. 11a is a diagram representing exemplary operation of a delivery application with respect to providing invoice objects to a buyer system in accordance with an exemplary embodiment of the present invention; and

FIG. 11b is a diagram representing exemplary operation of a delivery application with respect to providing a formatted invoice document to a buyer system in accordance with an exemplary embodiment of the present invention.

### DETAILED DESCRIPTION OF THE INVENTION

The present invention is now described in detail with reference to the drawings. In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

It should also be appreciated that many of the elements discussed in this specification may be implemented in a hardware circuit(s), a processor executing software code or instructions which are encoded within computer readable media accessible to the processor, or a combination of a hardware circuit(s) and a processor or control block of an integrated circuit executing machine readable code encoded within a computer readable media. As such, the term circuit, module, server, application, or other equivalent description of an element as used throughout this specification is intended to encompass a hardware circuit (whether discrete elements or an integrated circuit block), a processor or control block executing code encoded in a computer readable media, or a combination of a hardware circuit(s) and a processor and/or control block executing such code.

It should also be appreciated that table structures represented in this application are exemplary data structures only, of a non transitory nature embodied in computer readable memory, and intended to show the mapping of relationships between various data elements. Other table structures may store similar data elements in a manner that maintains the relationships useful for the practice of the present invention.

Within this application the applicant has depicted and described groups of certain elements. As used in this application, the term group (and the term community) means at least three of the elements. For example, a group of vendors means at least three vendors. When a group, for example a first group, is referred to as being distinct, or distinct from a second group, it means that the first group contains at least one element that is not present in the second group and the second group includes at least one element that is not present in the first group. The use of the term unique with respect to an element within a group or set of elements means that that the element is different then each other element in the set or group.

Within this application, the applicant has used the term database to describe a data structure which embodies groups of records or data elements stored in a volatile or non volatile storage medium and accessed by an application, which may be instructions coded to a storage medium and executed by a processor. The application may store and access the database.

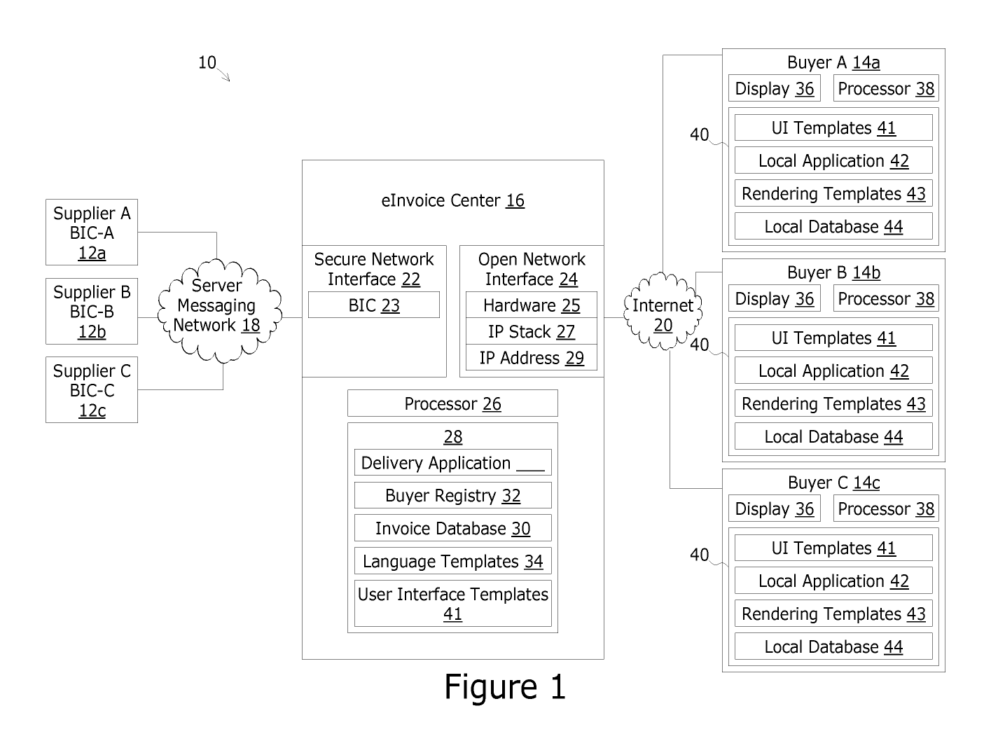

Turning to FIG. 1, an exemplary architecture 10 of a system for interfacing with a secure messaging network 18, such as the secure messaging network operated by the Society for Worldwide Interbank Financial Telecommunication (SWIFT Network), for electronic delivery of invoices over the secure messaging network 18 to each buyer 14a, 14b, 14c of a community of buyers, independent of whether each buyer 14a, 14b, 14c is part of the user base of the secure messaging network 18 or otherwise connected to the secure messaging network 18 for receipt of messages.

Coupled to the secure messaging network 18 are a group of suppliers 12a, 12b, 12c, each of which issues invoices to buyers of its products or services and delivers those invoices over the secure messaging network 18. For a group of buyers 14a, 14b, 14c which are not part of the user base of the secure messaging network 18, or otherwise connected to the secure messaging network 18, invoices are routed over the secure messaging network 18 to an shared data center 16. The group of buyers 14a, 14b, 14c are each coupled to an open network 20 such as the public Internet and receive invoices generated by the suppliers 12a, 12b, 12c from the shared data center 16 over the open network 20 as described herein.

The shared data center 16 may comprise computer readable media 28 coupled to a processor 26, a secure network interface 22 and an open network interface 24.

The secure network interface 22 may include an address code 23 such as a SWIFT Bank Identifier Code (BIC). The BIC uniquely identifies the shared data center 16 as part of the user base of the secure messaging network 18 and is used by the group of suppliers 12a, 12b, 12c as the destination address code for messages or files sent over the secure messaging network 18 to the shared data center 16—which include invoices intended for receipt by buyers 14a, 14b, 14c. The secure network interface 22 comprises of a secure web service (SOAP) call which is PKI certificated via to identify and authenticate the corporate connection.

The shared data center 16 may also comprise an open network interface 24. The open network interface comprises: i) physical layer network hardware 25 for communicating over a media interconnecting the shared data center 16 with its Internet service provider; ii) code 27 (commonly known as an “IP Stack”) embodied in computer readable media and executed by a processor for exchanging data using IP addresses and port numbers between applications operating at the shared data center and applications operating on remote computer systems coupled to the open network 20; and iii) an address code 29 such as a static and routable Internet Protocol (IP) address uniquely identifying the open network interface 24 as a routable destination on the open network 20.

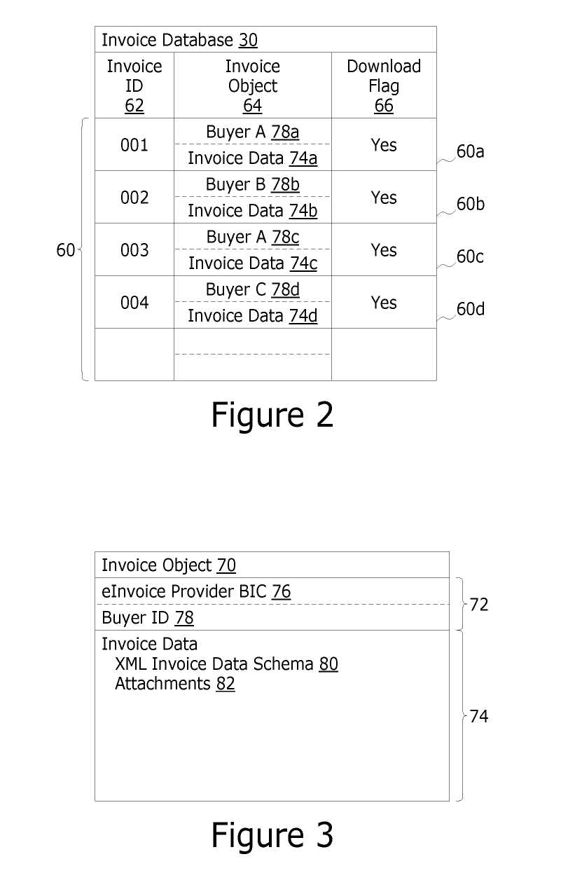

Turning briefly to FIG. 2 in conjunction with FIG. 1, an invoice database 30 may be coded to the computer readable media 28 and comprise a group of records 60. Each record 60a, 60b, 60c, 60d associates a unique invoice ID 62 with a unique invoice object 64 and a flag value 66 indicative of whether the invoice object 64 has been retrieved by the applicable buyer 14a, 14b, 14c.

Turning briefly to FIG. 3, an exemplary invoice object 70 may comprise a header 72 and a body 74. The header 72 may include the BIC of the shared data center 16 (i.e. BIC 23) as necessary for routing of the invoice object 70 to the shared data center 16 over the secure messaging network 18. The header 72 may also include a buyer ID 78 identifying a particular destination buyer 14a, 14b, or 14c of the group of buyers 14 to which the invoice object is to be delivered. Each buyer is identified by a unique alpha-numeric account reference and PKI certificate.

The body 74 of the invoice object includes invoice data. The invoice data may comprise data components of a standardized XML data schema 80—which may be an invoice data schema standardized by the ISO 20022 standard. The invoice data may also include attachments 82 which would typically be PDF files but could be attachments in other file formats which provide more detailed information about invoice line items.

Returning to FIG. 2, within the records 60 of the invoice database 30 are at least a first invoice object (record 60a for example) which includes identification of a first buyer (buyer A for example) and at least a second invoice object (record 60b for example) which includes identification of a second buyer (buyer B for example) unique from the first buyer. Each buyer is a distinct organization with responsibility for payment of invoices distinct from other buyers.

Further, within the records 60 of the invoice database 30 are at least a first invoice object (record 60a for example) which includes flag 66 indicative that the invoice has already been downloaded by the buyer and a second invoice object (record 60c for example) which includes flag 66 indicative that the invoice has not already been downloaded by that same buyer.

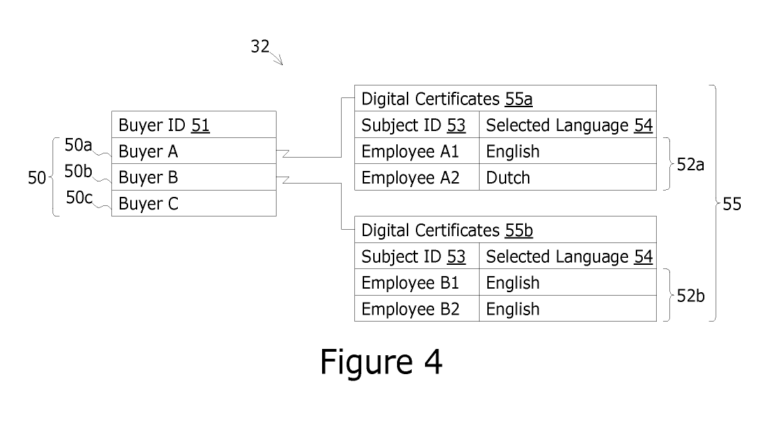

Turning briefly to FIG. 4 in conjunction with FIG. 1, a buyer registry 32 may be coded to the computer readable media 28 and comprise a group or records 50, each record 50a, 50b, 50c may be unique to one of the buyers 14a, 14b, 14c of the group of buyers 14 and identify the unique buyer by a buyer ID value 51. Associated with each buyer ID 51 are a group of access credentials 55a, 55b. For example, unique access credentials 55a may be associated with buyer A and unique access credentials 55b may be associated with Buyer B. The access credentials 55a, 55b associate with the buyer, identification of one or more individual(s) authorized by the buyer organization to obtain invoices from the shared data center 16.

The access credentials for each authorized individual may be in the form of a digital certificate issued by a certificate authority to the authorized individual. As such, associated with the record 50a for buyer A may be access credentials 55a comprising digital certificate records 52a, each of which identifies an authorized individual by a subject ID 53. Also uniquely associated with the authorized individual is identification of a selected language 54. The selected language identifier 54 indicates one of a group of languages in which: i) static content of invoices may be rendered; and ii) static content for a user interface for managing the buyer's invoice may be rendered. The selected language identifier (for example English) for a first authorized individual (for example Employee A1) may be distinct from the selected language identifier (for example Dutch) for a second authorized individual (for example Employee A2) for the same buyer (Buyer A).

Similarly, associated with the record 50 for Buyer B may be access credentials 55b comprising digital certificate records 52, each of which identifies an authorized individual (distinct from the authorized individuals for Buyer A) by a subject ID 53a. Again, uniquely associated with the authorized individual is identification of a selected language identifier 54.

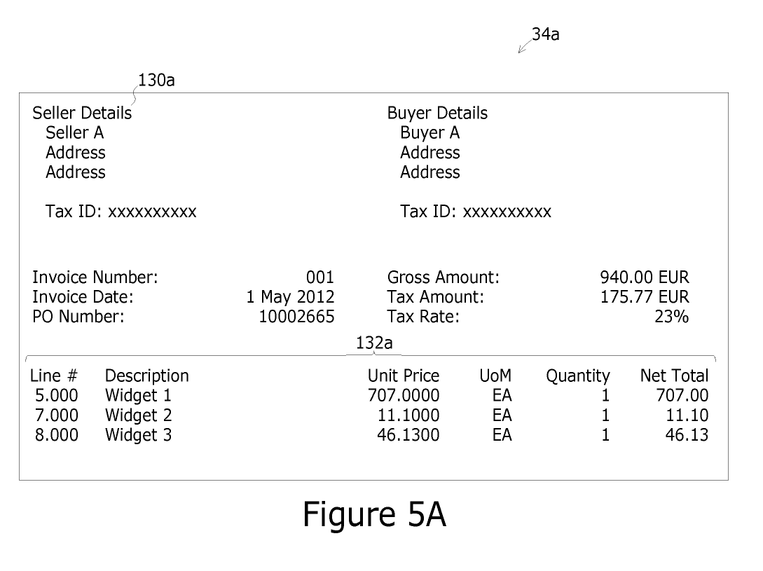

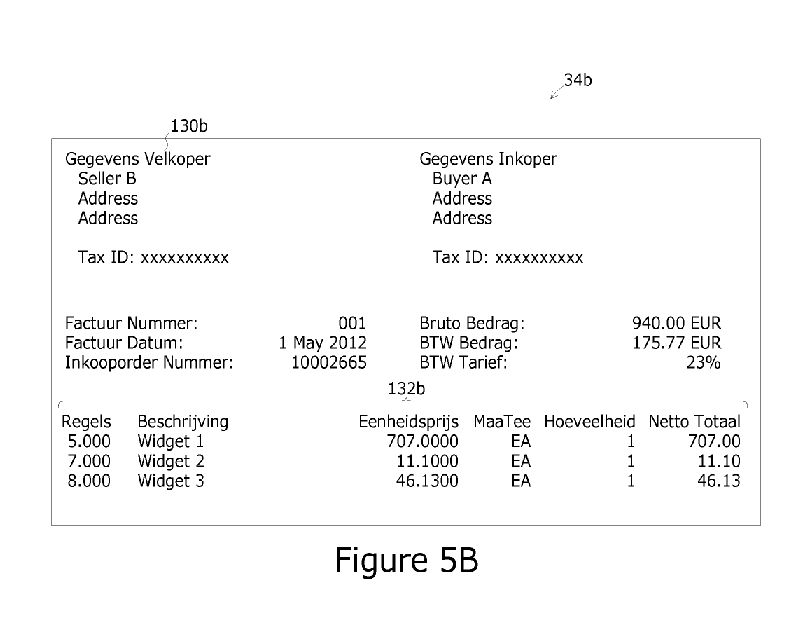

Returning to FIG. 1, language templates 34 may be coded to the computer readable media 28. Exemplary language templates 34 include templates for rendering invoices in multiple formats such as PDF, CSV, and other common formats, each with static content in one of multiple languages. For purposes of illustrating the present invention, a first rendering template 34a, in a first language (English) for a PDF format invoice is depicted in graphical form (as it would appear in a PDF) in FIG. 5a and a second rendering template 34b, in a second exemplary language (Dutch), distinct from the first language, for a PDF format invoice is depicted in graphical form in FIG. 5b.

Turning to FIG. 5a, the rendering template 34a includes static content for an invoice comprising: i) English language labels for data elements which are present within the invoice data 74 (FIG. 3) and reasonably require identification within a rendering of the invoice in human readable form and ii) positional information (represented by positional placement within FIG. 5a) for positioning each label and the corresponding invoice data string/value within the rendered invoice. For example, label “Seller Details” 130a may be a label used to identify data elements such as the seller's name (Seller A) and address—which are positioned below the label 130a. Labels 132a may identify data elements associated with each invoice line item and may be placed in position above a template table for populating such line item information for each line item of the invoice.

Similarly, with reference to FIG. 5b, the rendering template 34b includes static content for an invoice comprising: i) Dutch language labels for data elements which are present within the invoice data 74 (FIG. 3) and reasonably require identification within a rendering of the invoice in human readable form and ii) positional information (represented by positional placement within FIG. 5b) for positioning each label and the corresponding invoice data string/value within the rendered invoice. For example, label “Gegevens Velkoper” 130b may be a label used to identify data elements such as the seller's name (Seller B) and address—which are positioned below the label 130b. Labels 132b may identify data elements (in Dutch) associated with each invoice line item and may be placed in position above a template table for populating such line item information for each line item of the invoice.

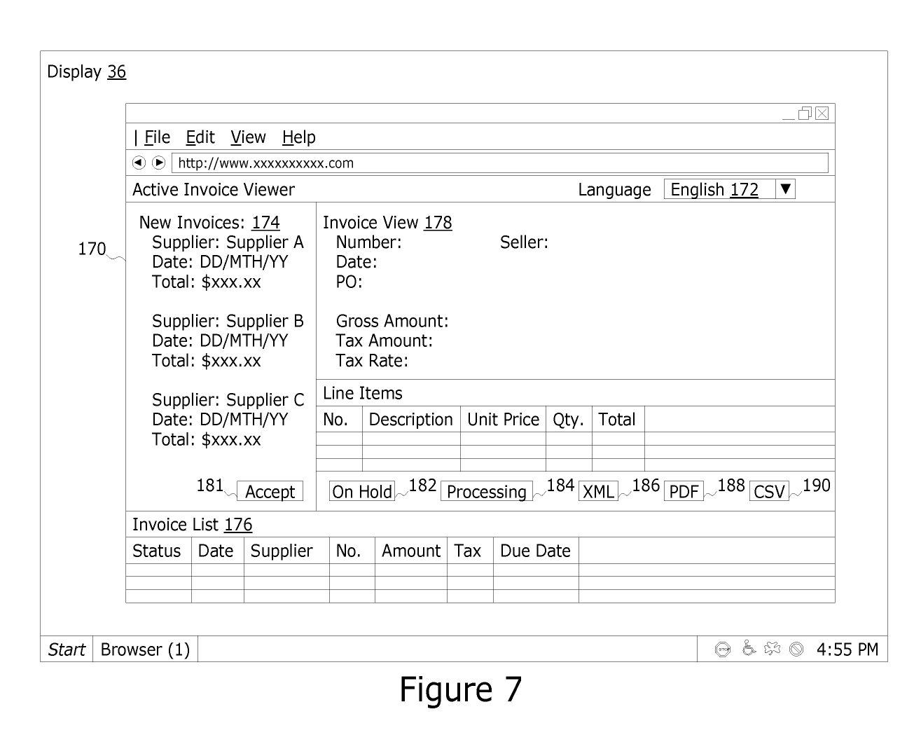

Returning to FIG. 1, user interface templates 31 may, in some embodiments, be coded to the computer readable media 28. Turning briefly to FIG. 1 in conjunction with FIG. 7, the user interface templates 31 include templates used by a local application for formatting and rendering invoice data within a user interface 170 on a display 36 of each buyer 14a, 14b, 14c. Each template may include static content in a distinct one of multiple languages.

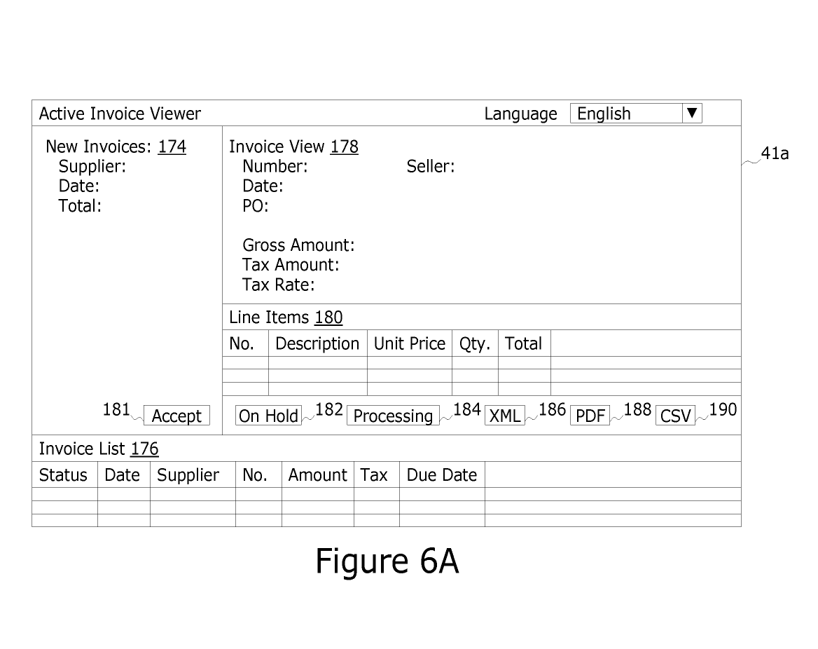

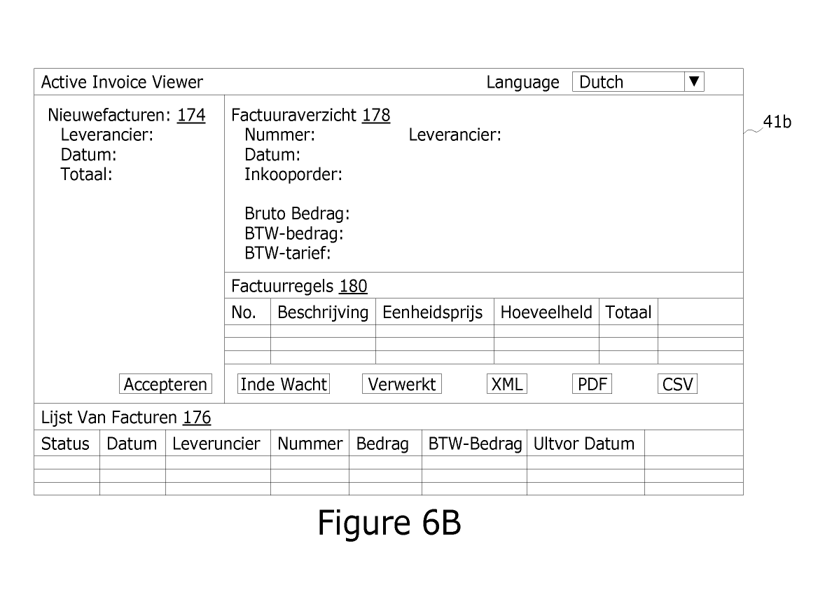

For example, turning to FIGS. 6a and 6b, for purposes of illustrating the present invention, a first user interface template 31a, in a first language (English) is depicted in graphical form (as it would appear on a display) in FIG. 6a and a second user interface template 31b, in a second exemplary language (Dutch), distinct from the first language, is depicted in graphical form in FIG. 6b.

The user interface template 41 a (FIG. 6a) includes static content for formatting and rendering invoice data within a user interface comprising: i) English language labels for data elements which are present within the user interface; ii) English language labels for controls 181, 182, 184, 186, 188, and 190 rendered within the user interface and iii) positional information (represented by positional placement within FIG. 6a) for positioning each label and the corresponding control or invoice data string/value within the rendered user interface 170 as depicted in FIG. 7.

The user interface 170, in general comprises three frames. A first frame 174 may be a frame for rendering listings of pending status invoices obtained from the shared data center 17 but not yet accepted. A second frame 176 may be a frame for rendering a listing (with summary information) of each invoice that has been accepted, whether on hold or processing. Stated another way, after an invoice is no longer pending, it may be listed in the second frame 176. A third frame 178 may be a frame for rendering detailed information of a single invoice selected from frame 176, inclusive of line items 180.

A such, template 41 a includes English language labels for data elements which are present within each of the frames 174, 176, 178 and positional information (represented by positional placement in FIG. 6a) for sizing and positioning each frame 174, 176, 179 and each label and the corresponding invoice data string/value within a rendering on the display 36 based on the template.

Control 181 may be used for accepting a pending invoice. Control 182 may be used for updating status of an invoice object to “on hold”. Control 184 may be used for updating status of an invoice object to “processing. Control 186 may be used for downloading or otherwise exporting an invoice object as an XML file. Control 188 may be used for downloading or otherwise exporting an invoice object as a PDF. Control 190 may be used for downloading or otherwise exporting an invoice objects as a file of comma separated values (i.e. a CSV file).

Turning to FIG. 6b, the user interface template 41 b includes static content (in Dutch) for rendering a user interface 170 on the buyer's display 36 (FIG. 7) comprising, in general, the three frames as described with respect to FIG. 6a.

The template 41b includes Dutch language labels for data elements which are present within each of the frames 174, 176, 178 and positional information (represented by positional placement in FIG. 6b) for sizing and positioning each frame 174, 176, 179 and each label and the corresponding invoice data string/value within a rendering on the display 36 based on the template. The template 41b may also include controls 182, 184, 186, 188, and 190, as described with respect to FIG. 6a and Dutch labels for those controls.

It should be appreciated that for multi-language support, the exemplary template 41 a includes all static content in a first language (English) and the second template 41b (FIG. 5b) includes all static content in a second exemplary language (Dutch), distinct from the first language.

Returning to FIG. 1, the shared data center 16 may further comprise a web services application, also known as a delivery application 35 coded to the computer readable media 28 and executed by the processor 26. The delivery application 35 may be communicatively coupled to the IP stack 27, at an application layer, and may be associated with certain port numbers for receiving web services method calls initiated by remote computing systems at each buyer location and responding to those web services calls as discussed herein.

Each buyer 14a, 14b, 14c, may be a networked computer system coupled to the open network 20 and include a display screen 36, a processor 38 and computer readable media 40.

In an exemplary embodiment, each buyer 14a, 14b, 14c is represented by an exemplary desktop or lap top computer, networked to the open network 20, with a display screen, a processor, random access memory, and hard drive or other storage (both the random access memory and the hard drive or other storage being computer readable media). The local database 44a, 44b, 44c may be coded to the hard drive and the viewing application is coded to the hard drive and loaded to the random access memory for execution by the processor.

Coded to the computer readable media may be a local database 44, and a viewing application 42. Also encoded to the computer readable media 40, optional for certain embodiments, may be: i) a group of invoice rendering templates 43, each with static content in one of multiple distinct languages as depicted and described with respect to FIGS. 5a and 5b; and ii) a group of user interface templates 41, each with static content in one of multiple distinct languages as depicted and described with respect to FIGS. 6a and 6b.

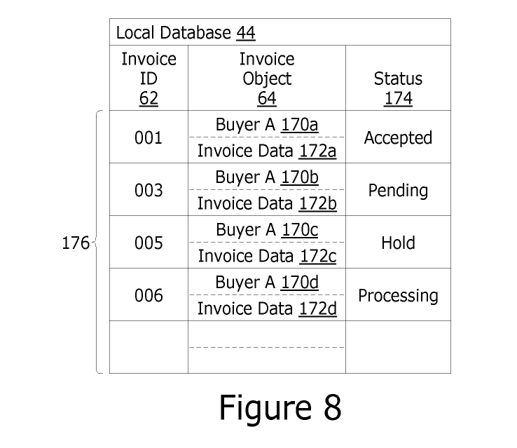

Turing to FIG. 8 the local database 44 for each buyer may comprise a group of records 176. Each record 176 associates the unique invoice ID 62 (as assigned by the shared data center 16 and used in the invoice database 30, FIG. 2) with a unique invoice object 64 for the buyer (Buyer A in the example depicted in FIG. 8) and a status value 174 indicative of one of a group of unique statuses applicable to the invoice object. Exemplary status values include: i) “accepted” which may mean that the invoice object obtained from the shared data center 16 has been accepted as an invoice to the buyer; ii) “pending” which may mean the invoice object obtained from the shared data center 16 has not yet been accepted as in invoice to the buyer; iii) “processing” which may mean an accepted invoice is undergoing processing by the buyer; and iv) “hold” which may mean an accepted invoice is not undergoing processing.

Each invoice object 64 is an invoice object obtained from the shared data center and has the characteristics and structure as described with respect to FIG. 3. More specifically, each invoice object 64 may include identification of Buyer A 170a, 170b, 170c, 170d, and invoice data 174a, 174b, 174c, 174d.

Returning to FIG. 1 in conjunction with FIG. 7, the instructions of the local viewing application 42 present at each buyer location provide for making web services calls to the shared data center 16 to obtain invoice objects and render a user interface 170 on the display 36, using invoice data from the invoice objects obtained from the shared data center 16 and a user interface template 41a or 41b (FIGS. 6a, 6b) as applicable to the language selected by the user.

The exemplary user interface 170 includes a language control 172 for user selection of one of a group of languages in which static content is displayed, depicted as English in FIG. 7. The exemplary use interface 170 further includes three frames simultaneously rendered.

A new invoices frame 174 displays summary information such as Supplier ID, Invoice Date, and Invoice total for each invoice within the local database 44 (FIG. 8) with a status of pending—indicating that the invoice object has been received from the shared data center 16 but not been accepted (i.e. status update to accepted by a user). An invoice list frame 176, distinct from new invoice frame 174, displays summary information such as status, invoice date, supplier ID, invoice number, invoice amount, tax amount, and due date for each invoice that has a status of acceptance or later (i.e. status other than pending such as accepted, hold, processing, or other post-acceptance status).

An invoice view frame 178, distinct from new invoice frame 174 and invoice list frame 176, displays detailed information about a single invoice from the database 44 (and selected within the invoice list frame 176). The detailed information may include detailed line item information 179 for multiple items.

The user interface 170 further includes controls 181, 182, 184, 186, 188, and 190 which may be selected by the user to initiate certain processes.

Selection of control 181 when an invoice within the new invoices frame 174 is highlighted or otherwise selected may initiate a process of updating the status of the selected invoice from pending to accepted.

Selection of control 182 when an invoice is present in the invoice view frame 187, or otherwise selected, may initiate a process of updating the status of the selected invoice to “on-hold”.

Selection of control 184 when an invoice is present in the invoice view frame 187, or otherwise selected, may initiate a process of updating the status of the selected is invoice to “processing”.

Selection of control 186 when an invoice is present in the invoice view frame 187, or otherwise selected, may initiate a process of either: i) downloading the selected invoice as an XML formatted document from the shared data center 16 using a download formatted invoice web services call as discussed herein; or ii) generating, from a local template, the selected invoice as an XML formatted document.

Selection of control 188 when an invoice is present in the invoice view frame 187, or otherwise selected, may initiate a process of either: i) downloading the selected invoice as an PDF formatted document from the shared data center 16 using a download formatted invoice web services call as discussed herein; or ii) generating, from a local template, the selected invoice as an PDF formatted document.

Selection of control 190 when an invoice is present in the invoice view frame 187, or otherwise selected, may initiate a process of either: i) downloading the selected invoice as an CSV formatted document from the shared data center 16 using a download formatted invoice web services call as discussed herein; or ii) generating, from a local template, the selected invoice as an CSV formatted document.

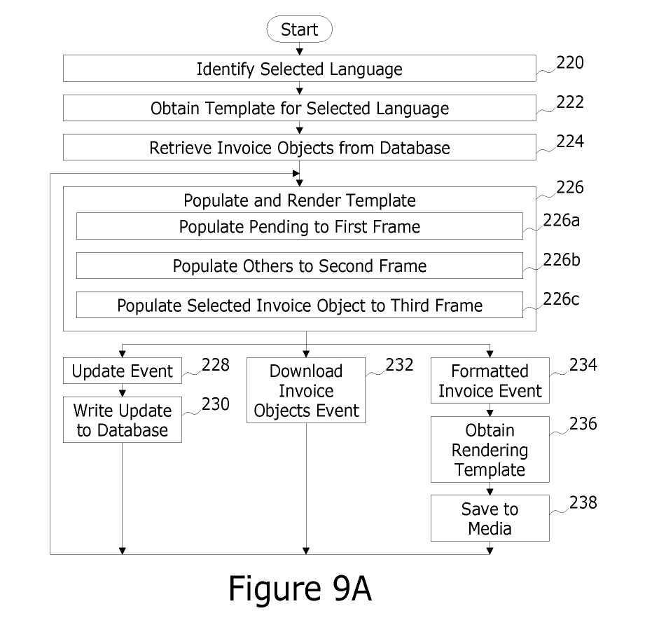

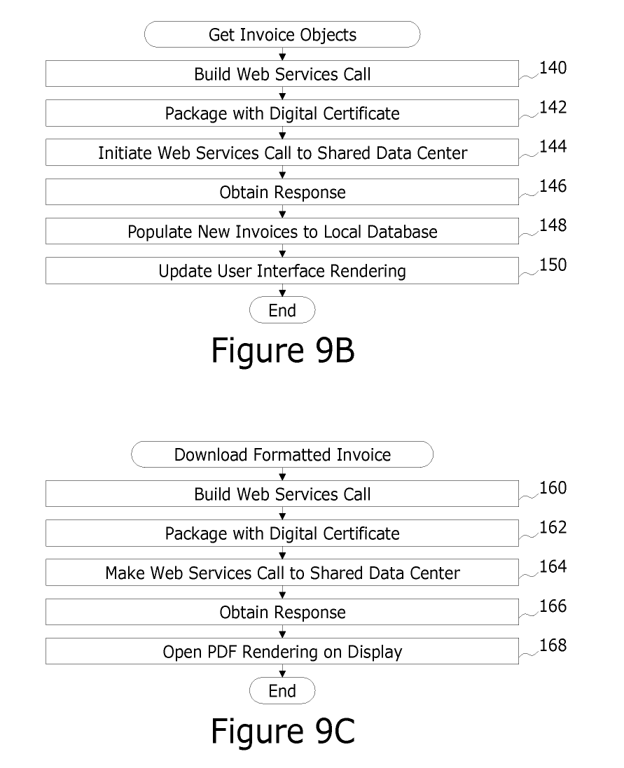

FIG. 9a represents exemplary aspects of operation of the local viewer application 42. Step 220 represents the application 42 identifying the selected language, for example, upon initial launch or start up of the application. This may include reading from local computer readable media 40 identification of the selected language from a previous operating instance of the application.

Step 222 represents obtaining the user interface template 41a, 41b (FIG. 6a, 6b) for the selected language. In one aspect, step 222 may represent obtaining the user interface template 41a, 41b from the local computer readable media 40. In another aspect, step 222 may represent obtaining the user interface template 41a, 41b from the shared data center 16 (as stored in computer readable media 28) using a web services call or other communication mechanism.

Step 224 represent retrieving invoice objects from the local database 44 and step 226 represents populating invoice data from the retrieved invoice objects to the user interface template to generate the user interface 170 on the display 36 as depicted in FIG. 7. More specifically, sub step 226a may represent populating invoice data from those invoice objects with a pending status to the new invoices frame 174. Sub step 226b may represent populating invoice data from those invoice objects with other than a pending status (i.e. accepted or later) to the invoice list frame 176. Sub step 226c may represent populating invoice data from a single selected invoice, including line items, to the invoice view frame 178.

Step 228 represents an update event. An update event may be any event which alters the status of an invoice including user selection of the accept control 181, the on hold control 182, or the processing control 184. In response thereto, at step 230 the update is written to the local database 44 and step 226 is re-performed to represent the update on the rendered user interface 170.

Step 232 represent a download invoice event to obtain new invoice objects from the shard data center 16. Steps performed by the local application upon a download invoice event are discussed herein with respect to FIG. 9b.

Step 234 represents a formatted invoice event. A formatted invoice event may be any event which requires formatting of invoice data into an invoice document including user selection of the XML control 186, the PDF control 188, or the CSV control 190.

In one aspect, steps performed by the local application to download a formatted invoice form the shared data center 16 in response to a formatted invoice event are discussed with respect to FIG. 9c. In another aspect, formatting of the invoice may be performed locally by the application 42, at step 236, obtaining the applicable invoice template, for example selecting PDF template 43a, 43b (FIG. 5a, 5b) in response to user selection of PDF control 188, in the selected language, from the local database 44. In another aspect, formatting of the invoice may be performed locally by the application 42, at step 236, obtaining the applicable invoice template, for example obtaining PDF template 43a, 43b (FIG. 5a, 5b) from the shared data center 16 in response to user selection of PDF control 188, in the selected language, for example, by way of web services call or other communication mechanism.

Step 238 represents populating invoice data from the selected invoice object to the template and step 240 represents opening a local viewer for the formatted invoice or saving the formatted invoice to local computer readable media 40 for subsequent processing.

Turning to FIG. 9b, exemplary operation of an aspect of the local viewer application 42 for retrieving new invoice objects from the shared data center 16 is represented. Step 140 represents building a get invoice objects web services call in compliance with the WSDL published by the shared data center 16 for a get invoice objects web services call.

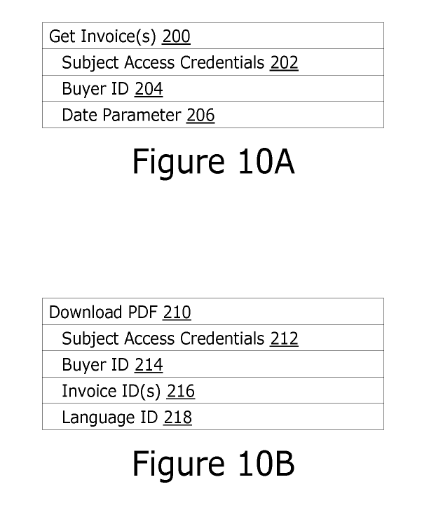

Turning briefly to FIG. 10a, an exemplary get invoices web services call 200 may include at least: i) the subjects access credentials 202; ii) a buyer ID 204; and iii) a date parameter 206. The subject access credentials 202 may be the digital certificate assigned to the individual with responsibility for obtaining invoices for the buyer from the shared data center, such access credentials matching access credentials for one of the records 52a, 52b associated with the buyer in the buyer registry 32. The buyer ID 204 may be the same as buyer ID 51 for identifying the buyer within the buyer registry 32. The date parameter 206 may be a parameter for identifying which invoice objects the shared data center 16 is to return in response to the web services call. The date parameter 206 may indicate: i) a start date (i.e. obtain all invoice objects with an invoice date after the start date); ii) an end date (i.e. obtain all invoice objects with an invoice date before the end date); iii) both (i.e. obtain all invoice objects with an invoice date between the start date and the end date; or iv) other parameters indicated of which invoice objects to obtain.

Returning to FIG. 9b, step 142 represents packaging the web services call with the subjects digital certificate (access credentials of the connecting buyer) and step 144 represents initiating the signed web services call to the shared data center 16.

Step 146 represents receiving, in response to the web services call, a group of invoice objects which, as discussed with respect to FIG. 9a, are those invoice objects which include identification of the connecting buyer within the header of the invoice object and step 148 represents storing those invoice objects returned form the shared data center in the local database 44 with an initial status 174 (FIG. 8) of “Pending”.

Steps 150 represents rendering, or updating the rendering, of the user interface 170, as depicted in FIG. 7, on the display 36 to include data from the invoice objects obtained in response to the web services call.

FIG. 9c represents exemplary operation of an aspect of the local viewer application 42 for downloading a formatted invoice from the shared data center 16. Step 160 represents building a download formatted invoice web services call in compliance with the WSDL published by the shared data center 16 for a download formatted invoice web services call. Step 162 represents packaging the web services call with the subjects digital certificate (access credentials of the connecting buyer) and step 164 represents initiating the signed web services call to the shared data center 16.

Turning briefly to FIG. 10b, an exemplary download invoice (in PDF format) web services call 210 may include at least: i) the subjects access credentials 212; ii) a buyer ID 244; and iii) an invoice ID 216; and iv) optionally in some embodiments, a language ID 218. The subject access credentials 212 may be the digital certificate assigned to the individual with responsibility for obtaining invoices for the buyer from the shared data center, such access credentials matching access credentials for one of the records 52a, 52b associated with the buyer in the buyer registry 32. The buyer ID 214 may be the same as buyer ID 51 for identifying the buyer within the buyer registry 32. The invoice ID 216 may be the same invoice ID 62 for identifying an invoice object within the invoice database 30 of the shared data center 16. The language ID 218, which is optional in some embodiments, may identify a distinct one of multiple languages in which static content of the invoice is to be rendered.

Returning to FIG. 9c, step 166 represents receiving, in response to the web services call, a file containing the invoice data 74 (FIG. 8) of the identified invoice (identified in the web services call) populated to a template with static content in the rendering language associated with the subject making the web services call as fully formatted document such as a PDF file.

Steps 168 represents providing the file, with launch instructions, to a PDF viewer (stored in computer readable media and executed by the processor) for rendering on the display, printing, saving to the computer readable media, or other applicable operations.

The delivery application 35 may be a known web services front end which utilizes the simple object access protocol (SOAP) for exchanging XML messages with remote systems (and in particular the viewing application of each buyer 14a, 14b, 14c operating at the buyer's remote location) using secure socket connections (e.g. SSL Connections) over the Internet 20.

The delivery application 35 may publish a WSDL document describing the data processing services (e.g. transfer methods) provided by the delivery application 35 (i.e. the obtain new invoice objects method and the download invoice method) and, upon receiving a method call from a remote system, such as a buyer 14a, 14b, 14c, execute the applicable transfer method and thereby provide the data processing service to the remote system making the method call.

For example, the delivery application 35, in response to a get invoice objects web services call from a particular buyer 14a, 14b, 14c returns a group of invoice objects to the buyer 14a, 14b, 14c, or more specifically, to the buyer's local application 42 which in turn renders information from those objects within the user interface 170 for viewing on the buyer's display screen 36 (FIG. 7).

The delivery application 35, in response to a download invoice web services call from a particular buyer 14a, 14b, 14c, which identifies the invoice and the format, returns a generates a file including the specified identified invoice in the specified format and returns that file to the buyer 14a, 14b, 14c, or more specifically, to the buyer's local application 42.

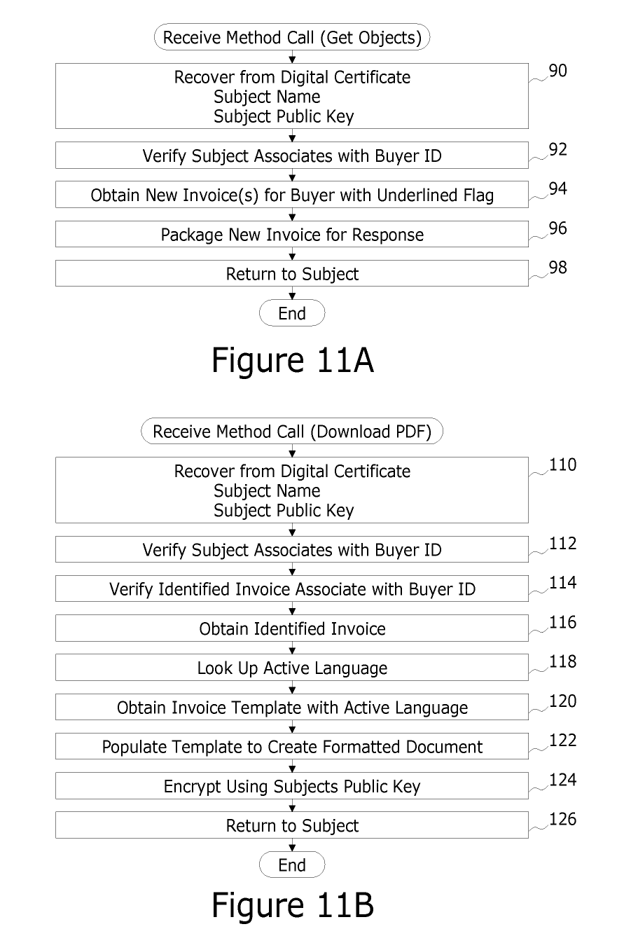

Turning to FIG. 11a, a first exemplary transfer method, get invoice objects, may include instructions which provide one or more invoice objects 70 to a buyer 14a, 14b, 14c making a web services call to the shared data center 16.

More specifically, in response to receipt of a get invoice objects web services call which includes access credentials in the form of a digital certificate assigned to a subject associated with a buyer 14a, 14b, 14c generating the call (i.e. the connecting buyer), the instructions of the delivery application 35 may, at step 90, recover a subject identifier and public key from a digital certificate used to make the web services call.

At step 92, the delivery application 35 recovers the web services call (i.e. the information conforming with the WSDL) and verifies that the of the subject identifier from the digital certificate matches access credentials of an individual authorized by the buyer as identified by the buyer ID within the web services call.

At step 94, only if the subject identifier from the digital certificate matched the access credentials of an individual authorized by the buyer, the delivery application 35 obtains new invoice objects for the buyer, meaning invoice objects that have not previously been obtained by the connecting buyer. Returning briefly to FIG. 2, the download flag identifier 66 of the invoice database 30 may, for each invoice object, be populated with: i) a first flag value indicating that the invoice object has not been downloaded; and ii) a second flag value indicating that the invoice object has been downloaded. As such, Step 94 may include retrieving, from the invoice database 30, those invoice objects which include identification of a destination buyer in the header which match identification of the connecting buyer (i.e. the buyer with which the subject to associated in the buyer registry 32) and for which with the flag indicates that the invoice object has not yet been downloaded.

At step 96 the delivery application may package a response to the web services call, including applicable digital certificate encryption, and, at step 98, return the packaged new invoice objects to the connecting buyer.

Turning to FIG. 11b, a second exemplary transfer method, download invoice, may include instructions which provide one or more files containing the invoices specified in the web services call, in the format specified in the web services call, to the connecting buyer 14a, 14b, 14c.

More specifically, in response to receipt of a download invoice web services call which includes access credentials in the form of a digital certificate assigned to a subject associated with a connecting buyer 14a, 14b, 14c generating the call the delivery application may, at step 110, recover a subject identifier and public key from a digital certificate used to make the web services call.

At step 112, the delivery application 35 recovers the web services call (i.e. the information conforming with the WSDL) and verifies that the of the subject identifier from the digital certificate matches access credentials of an individual authorized by the buyer as identified by the buyer ID within the web services call. More specifically, the access credentials are validated by determining whether the subject identified in the digital certificate of the web services call matches a subject ID 53a or 53b within a record 52a or 52b associated with the buyer identified in the web services call.

At step 114, only if the subject identifier from the digital certificate matched the access credentials of an individual authorized by the buyer, the delivery application 35 verifies whether an invoice identified in the web services call is associated with the connecting buyer (i.e. is the subject requesting an invoice that is intended for the buyer). More specifically the delivery application 35 verifies that the buyer ID of the requested invoice matched the buyer ID with which the subject is associated in the buyer registry 32.

Step 116 represents obtaining the identified invoice, subject to the preceding verification, and step 118 represents looking up, in the buyer registry 32 (FIG. 4), the selected language 54a, 54b which associates with the subject.

Using a PDF formatted invoice for example, step 120 represents looking up the selected language 54 (i.e. the rendering language) associated with the subject in the buyer registry 32 (FIG. 4) and obtaining the invoice template 34a or 34b (FIGS. 5a and 5b) matching the selected language and step 122 represents populating the invoice data 74 (FIG. 3) of the selected invoice to the applicable rendering template 34a, 34b to create a fully formatted language specific invoice document with static content being in the selected language.

Step 124 represents encrypting using the subject's public key and step 126 represents returning the fully formatted invoice document to the subject.

In summary, the present invention provides a system for delivering invoices over the SWIFT Network to a community of buyers comprises an invoice viewer at each buyer's location, each connected to a shared data center over the Internet. Although the invention has been shown and described with respect to certain exemplary embodiments, it is obvious that equivalents and modifications will occur to others skilled in the art upon the reading and understanding of the specification. It is envisioned that after reading and understanding the present invention those skilled in the art may envision other processing states, events, and processing steps to further the objectives of system of the present invention. The present invention includes all such equivalents and modifications, and is limited only by the scope of the following claims.

What is claimed is:

1. A system for interfacing with the Society for Worldwide Interbank Financial Telecommunication (SWIFT) Network for delivery of invoices to each buyer of a community of buyers, the system comprising:
a shared data center, the shared data center comprising:
a bank identification code (BIC) identifying the shared data center as an addressable endpoint on the SWIFT Network;
a SWIFT Network Interface connecting the shared data center with the SWIFT Network and receiving SWIFT invoice formatted messages addressed to the BIC;
a database encoded to computer readable medium, the database comprising:
a group of invoice objects, each invoice object comprising:
a header comprising the BIC and identification of destination buyer, the destination buyer being a buyer of the group of buyers; and
invoice data;
at least a first invoice object including identification of a first destination buyer; and
at least a second invoice object including identification of a second destination buyer unique from the first destination buyer;
a group of buyer records, each buyer record associated with and identifying a unique buyer of the group of buyers and access credentials unique to the unique buyer;
a delivery application comprising instructions stored in a computer readable memory and executed by a processor, the instructions comprising, in response to receipt of a web services call which includes access credentials of a connecting buyer, the connecting buyer being a buyer of the group of buyers,
validating that the access credentials within the web services call match access credentials within a buyer record of one of the unique buyers;
retrieving from the database those invoice objects which include identification of a destination buyer in the header which matches identification of the connecting buyer and providing those retrieved invoice objects to the connecting buyer;
an invoice viewer comprising a computer readable memory and executed by a processor, each at the connecting buyer's location remote from the shared data center, the instructions comprising:
invoice retrieval instructions, the invoice retrieval instructions comprising:
generating a web services call to the delivery application, the web services call comprising the connecting buyer's access credentials;
receiving, in response to the web services call, a group of invoice objects which include identification of the connecting buyer within the header of the invoice object;
storing the invoice objects in a local database;
user interface instructions, the user interface instructions comprising:
rendering, within a first frame of a user interface display, summary information for each invoice received in response to the web services call;
rendering, within a second frame of the user interface display, detailed information of a selected invoice object, the selected invoice object being a one of the invoices received in response to the web services call.

2. The system of claim 1, wherein:
the shared data center further comprises:
a group of invoice rendering templates, each invoice rendering template comprising static invoice content in one language of a group of distinct languages; and
the instructions of the delivery application further comprise, in response to receipt of a web services call which includes access credentials of the connecting buyer and identification of an invoice object:
validating that the access credentials within the web services call match access credentials within a buyer record of one of the unique buyers;
retrieving from the database the identified invoice object;
looking up a rendering language, the rendering language being a language selected by the user for rendering of invoices;
populating the invoice data of the identified invoice object to the invoice rendering template with static content in the rendering language to generate a language specific formatted document file; and
providing the formatted document file to the connecting buyer.

3. The system of claim 2, wherein:
each buyer record further includes identification of the rendering language selected by the user for rendering invoices; and
looking up the rendering language comprises looking up the rendering language in the buyer record associated with the connecting buyer.

4. The system of claim 2, wherein:
the web services call further includes identification of the rendering language selected by the user for rendering invoices; and
looking up the rendering language comprises looking up the rendering language in the web services call received from the connecting buyer.

5. The system of claim 1, wherein the invoice viewer further includes:
a group of user interface rendering templates, each user interface rendering template comprising static content of the user interface display in one language of a group of distinct languages;
the user interface instructions further comprise:
looking up a selected language, the selected language being a language selected by the user for the user interface;
rendering, by use of the user interface rendering template with static content in the selected language:
the summary information for each invoice received in response to the web services call within the first frame of the user interface display; and
the detailed information of the selected invoice object within the second frame of the user interface display.

6. The system of claim 5, wherein:
the computer readable media at the connecting buyer's location comprises encoded thereon identification of selected language; and
looking up the selected language comprises looking up the selected language from the computer readable media.

7. The system of claim 5, wherein;
the response to the web services call further comprises identification of the selected language; and
looking up the selected language comprises looking up the selected language from the response to the web services call.

8. The system of claim 5, wherein:
the shared data center further comprises:
a group of invoice rendering templates, each invoice rendering template comprising static invoice content in one language of a group of distinct languages; and
the instructions of the delivery application further comprise, in response to receipt of a web services call which includes access credentials of the connecting buyer and identification of an invoice object:
validating that the access credentials within the web services call match access credentials within a buyer record of one of the unique buyers;
retrieving from the database the identified invoice object;
looking up a rendering language, the rendering language being a language selected by the user for rendering of invoices;
populating the invoice data of the identified invoice object to the invoice rendering template with static content in the rendering language to generate a language specific formatted document file; and
providing the formatted document file to the connecting buyer.

9. The system of claim 8, wherein:
each buyer record further includes identification of the rendering language selected by the user for rendering invoices; and
looking up the rendering language comprises looking up the rendering language in the buyer record associated with the connecting buyer.

10. The system of claim 8, wherein:
the web services call further includes identification of the rendering language selected by the user for rendering invoices; and
looking up the rendering language comprises looking up the rendering language in the web services call received from the connecting buyer.

11. A system for interfacing with the SWIFT Network for delivery of invoices to each buyer of a community of buyers, the system comprising:
a shared data center, the shared data center comprising:
a bank identification code (BIC) identifying the shared data center as an addressable endpoint on the SWIFT Network;
a SWIFT Network Interface connecting the shared data center with the SWIFT Network and receiving SWIFT invoice formatted messages addressed to the BIC;
a database encoded to computer readable medium, the database comprising:
a group of invoice objects, each invoice object comprising:
a header comprising the BIC and identification of destination buyer, the destination buyer being a buyer of the group of buyers; and
invoice data;
at least a first invoice object including identification of a first destination buyer; and
at least a second invoice object including identification of a second destination buyer unique from the first destination buyer;
a group of buyer records, each buyer record associated with an identifying a one unique buyer of the group of buyers and access credentials unique to the unique buyer;
a group of invoice rendering templates, each invoice rendering template comprising static invoice content in one language of a group of distinct languages; and
a delivery application comprising instructions stored in a computer readable memory and executed by a processor, the instructions comprising, in response to receipt of a download invoice web services call which includes access credentials of a connecting buyer and identification of an invoice object, the connecting buyer being a buyer of the group of buyers,
validating that the access credentials within the web services call match access credentials within a buyer record of one of the unique buyers;
validating that the identified invoice object matches the destination buyer identified in the header of the invoice object;
looking up a rendering language, the rendering language being a language selected by the user for rendering of invoices;
populating the invoice data of the identified invoice object to the invoice rendering template with static content in the rendering language to generate a language specific formatted document file; and
providing the formatted document file to the connecting buyer.

12. The system of claim 11, wherein:
each buyer record further includes identification of the rendering language selected by the user for rendering invoices; and
looking up the rendering language comprises looking up the rendering language in the buyer record associated with the connecting buyer.

13. The system of claim 11, wherein:
the web services call further includes identification of the rendering language selected by the user for rendering invoices; and
looking up the rendering language comprises looking up the rendering language in the web services call received from the connecting buyer.

14. The system of claim 11, wherein the delivery application further comprises, in response to receipt of an obtain SWIFT invoice web services call which includes access credentials of the connecting buyer;
validating that the access credentials within the web services call match access credentials within a buyer record of one of the unique buyers; and
retrieving from the database those invoice objects which include identification of a destination buyer in the header which matches identification of the connecting buyer and providing those retrieved invoice objects to the connecting buyer.

15. The system of claim 14, further comprising an invoice viewer comprising a computer readable memory and executed by a processor, each at the connecting buyer's remote location, the instructions comprising:
invoice retrieval instructions, the invoice retrieval instructions comprising:
generating a web services call to the delivery application Invoice retrieval instructions, the web service call comprising the connecting buyer's access credentials;
receiving, in response to the web services call, a group of invoice objects which include identification of the connecting buyer within the header of the invoice object;
storing the invoice objects in a local database;
user interface instructions, the user interface instructions comprising:
rendering, within a first frame of a user interface display, summary information for each invoice received in response to the web services call;
rendering, within a second frame of the user interface display, detailed information of a selected invoice object, the selected invoice object being a one of the invoices received in response to the web services call.

16. The system of claim 15, wherein the invoice viewer further includes:
a group of user interface rendering templates, each user interface rendering template comprising static content of the user interface display in one language of a group of distinct languages;
the user interface instructions further comprise:
looking up a selected language, the selected language being a language selected by the user for the user interface;
rendering, by use of the user interface rendering template with static content in the selected language:
the summary information for each invoice received in response to the web services call within the first frame of the user interface display; and
the detailed information of the selected invoice object within the second frame of the user interface display.

17. The system of claim 16, wherein:
the computer readable media at the connecting buyer's location comprises encoded thereon identification of selected language; and
looking up the selected language comprises looking up the selected language from the computer readable media.

18. The system of claim 16, wherein;
the response to the web services call further comprises identification of the selected language; and
looking up the selected language comprises looking up the selected language from response to the web services call.

19. The system of claim 14, further comprising an invoice viewer comprising a computer readable memory and executed by a processor, each at the connecting buyer's remote location, the instructions comprising:
invoice retrieval instructions, the invoice retrieval instructions comprising:
generating a web services call to the delivery application Invoice retrieval instructions, the web service call comprising the connecting buyer's access credentials;
receiving, in response to the web services call, a group of invoice objects which include identification of the connecting buyer within the header of the invoice object;
storing the invoice objects in a local database;
user interface instructions, the user interface instructions comprising:
rendering, within a first frame of a user interface display, summary information for each invoice stored in the local database with a status of new;
rendering, within a second frame of the user interface display, detailed information of a selected invoice object, the selected invoice object being a one of the invoices received in response to the web services call;
rendering, within a third frame of the user interface display, summary information for each invoice stored in the local database with a status of received.

20. The system of claim 19, wherein the invoice viewer further includes:
a group of user interface rendering templates, each user interface rendering template comprising static content of the user interface display in one language of a group of distinct languages;
the user interface instructions further comprise:
looking up a selected language, the selected language being a language selected by the user for the user interface;
rendering, by use of the user interface rendering template with static content in the selected language:
the summary information for each invoice stored in the local database with the status of new within the first frame of the user interface display;
the detailed information of the selected invoice object within the second frame of the user interface display; and
the summary information for each invoice stored in the local database with the status of received within the third frame of the user interface display.
